(19) United States
(12) Patent Application Publication
(10) Pub. No.: US 2005/0042909 A1
(43) Pub. Date: Feb. 24, 2005

(54) Zero insertion force socket

(76) Inventor: Xudong Sun, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/935,818

(22) Filed: Sep. 7, 2004

(30) Foreign Application Priority Data
Sep. 9, 2003 (TW) 92216115

(51) Int. Cl. H01R 4/50

(52) U.S. Cl. 439/342

(57) ABSTRACT

A zero insertion force socket (1) for electrically connecting a central processing unit (CPU) with a printed circuit board (PCB) comprises a base (10), a cover (20) slidably mounted on the base, and terminals (30) received in the base, a rotatable cam actuator (40) for actuating the cover to slide on the base, a protecting mechanism (50) and a washer (60) mounted between the cover and the base. The protecting mechanism comprises a cover plate (51) in the cover and a bottom plate (52) in the base. The cover plate defines an elongated slot (512). A pair of opposite cam stoppers (515) extends upwardly from one side of the slot. The cam actuator has a protrusion (45) abutting against one of the cam stoppers during rotation.

### BACKGROUND OF THE INVENTION

1. Field of the Invention

The present invention relates to an electrical socket, and particularly to a zero insertion force (ZIF) socket for electrically connecting an electronic package such as a pin array (PGA) chip with a circuit substrate such as a printed circuit board (PCB).

2. Description of the Prior Art

Electrical sockets are widely used in the connector industry for electrically connecting central processing units (CPUs) to printed circuit boards (PCBs) in personal computers (PCs). Such as electrical socket is disclosed in U.S. Pat. No. 6,254,415. One example of such connectors comprises a plastic base, a plastic cover mounted on the base, a plurality of terminals received in the base, and a metallic cam actuator engaged between the cover and the base. The cover is actuated to slide on the base by rotation of the cam actuator, thereby causing pins of the CPU mounted on the cover to engage with/disengage from the terminals in the base. Referring to FIG. 5, the electrical socket is designed for electrically interconnecting a CPU (not shown) with a PCB (not shown). The ZIF socket comprises a base (not shown), a plastic cover 8 mounted on the base, a multiplicity of terminals (not shown) received in the base, and a cam actuator 9 engaged between the base and the cover 8. The plastic cover 8 of the socket defines an arc-shaped recess 81 in one side thereof. A stop wall 82 is provided at each end of the arc-shaped recess 81. The metallic cam actuator 9 comprises an outwardly protruding protrusion 91. The protrusion 91 of the cam actuator 9 is rotatable in the arc-shaped recess 81. Rotation of the cam actuator 9 causes the cover 8 to slide on the base, mating or unmating the pins of the CPU on the cover 8 with the terminals (not shown) of the base.

However, when the protrusion 91 rotates between the two limit positions defined by the stop walls 82 and abuts against one of the stop walls 82, the large force exerted by the protrusion 91 may tend to damage the stop wall 82 during operation of the ZIF socket. Further, the cover is apt to be worn out by the rotation of the cam actuator 9 therein, resulting in a shortened life thereof, and in turn a shortened life of the ZIF socket.

Therefore, a new electrical socket which overcomes the above-mentioned problems is desired.

### SUMMARY OF THE INVENTION

An object of the present invention is to provide a ZIF socket for electrically connecting an electronic package such as an PGA chip with a circuit substrate such as a PCB, whereby the ZIF socket is configured to ensure reliable electronic connection between the socket and an associated electronic package.

Another object of the present invention is to provide a ZIF socket having a protecting mechanism which protects the cover and the base of the ZIF socket for lengthened life.

To achieve the above objects, a ZIF socket of the present invention is for electrically connecting a central processing unit (CPU) with a mother board. The socket comprises an insulative base, a dielectric cover mounted on the base, a plurality of terminals received in the base, a metallic cam actuator for actuating the cover to slide on the base, a protecting mechanism and a washer mounted between the cover and the base. The base comprises a first housing, a first opening and a plurality of passageways. The first housing defines a T-shaped recess in a middle portion of an end thereof. A bottom of the recess defines a through hole. The cover comprises a second housing, a second opening and a ledge. The ledge has a top hole and a pair of stop walls. The protecting mechanism comprises T-shaped metal cover plate insert molded in the cover and a T-shaped metallic bottom plate received in the recess of the base. The cover plate defines an elongated slot and a pair of arc-shaped holes provided on opposite sides of the slot at the middle and in communication with the slot. The two arc-shaped holes define a through hole together with a middle portion of the slot. A pair of upwardly extending cam stoppers are provided on one side of the slot and on opposite sides of one arc-shaped hole. The bottom plate defines a rectangular through hole in the middle thereof. The cam actuator comprises an upper disk, a lower disk and a lower cam block. The upper disk has a lateral protrusion protruding from a side thereof. The cam block comprises a riveting end coaxial with the cam block at a lower end thereof. The rotational axis of the cam block is offset from a rotational axis of the lower disk. Rotation of the cam actuator causes the cover to slide on the base, mating or unmating pins of the CPU on the cover with the terminals of the base.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a ZIF socket in accordance with the preferred embodiment of the present invention, showing only one conductive terminal thereof;

FIG. 2 is an assembled view of FIG. 1;

FIG. 3 is a bottom, isometric view of a cover of the ZIF socket in accordance with the present invention;

FIG. 4 is a partial, top plan view illustrating the engagement between a cam actuator and a cover plate of a protecting mechanism of FIG. 1 in accordance with the present invention; and

FIG. 5 is a partial, top plan view illustrating the engagement between a cam actuator and a conventional protecting mechanism of the ZIF socket.

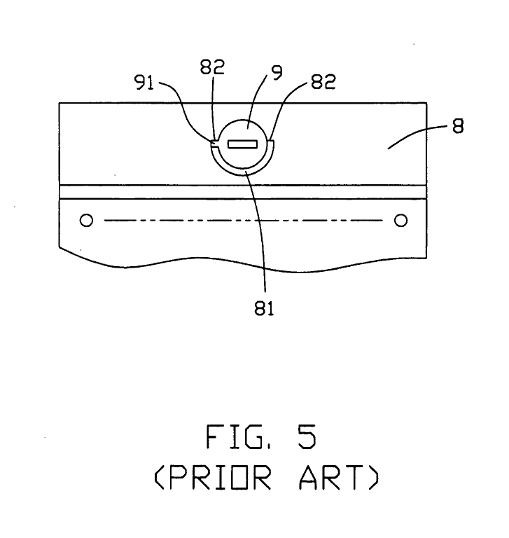

### DESCRIPTION OF THE PREFERRED EMBODIMENT

Reference will now be made to the drawings to describe the present invention in detail.

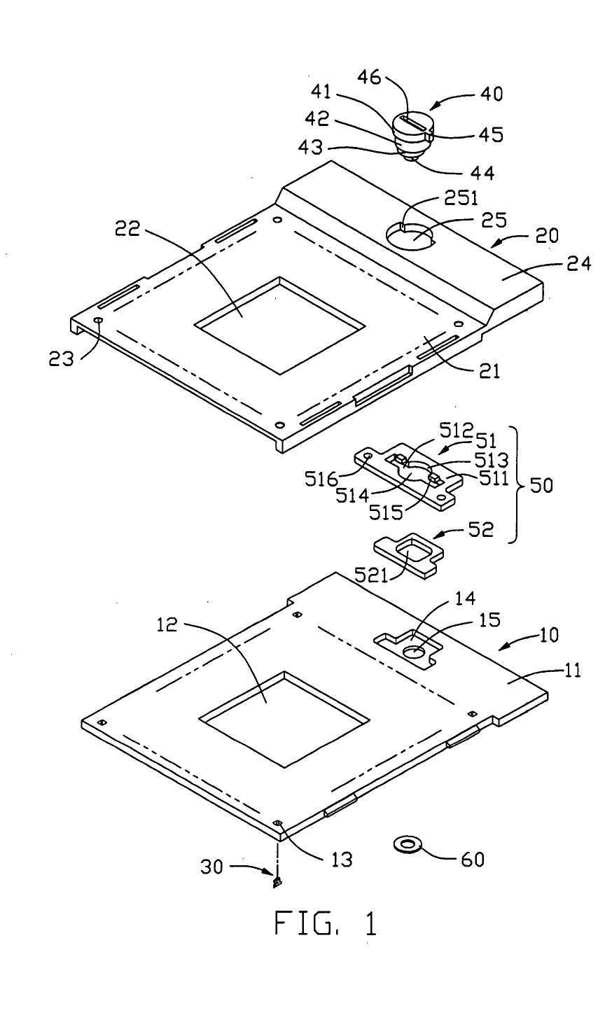

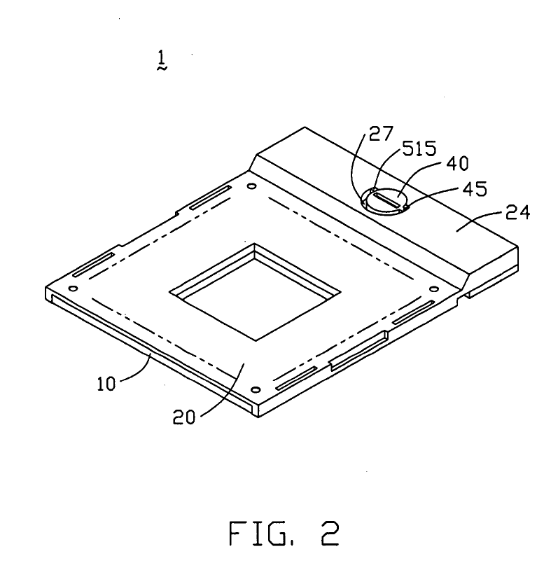

Referring to FIGS. 1 and 2, a ZIF socket 1 in accordance with a preferred embodiment of the present invention comprises a dielectric base 10, a cover 20 slidably mounted on the base 10, and a multiplicity of terminals 30 received in corresponding passageways 13 defined through the base 10 for electrically connecting pins of a central processing unit (CPU) (not shown) with a mother board (not shown), a metallic cam actuator 40 engaged between the base 10 and the cover 20, and a protecting mechanism 50 and a washer 60.

The base 10 is generally square-shaped and comprises an insulative first housing 11, an opening 12 defined in a middle of the first housing 11 and a multiplicity of passageways 13 extending vertically through the first housing 11 to received the corresponding terminals 30. The first housing 11 comprises a T-shaped recess 14 in a middle of an end thereof. The bottom of the recess 14 defines a through hole 15.

The cover 20 is configured to engage with the base 10 and comprises an insulative second housing 21, an opening 22 defined in a middle of the second housing 21 and a ledge 24 defined at one end thereof. A multiplicity of passages 23 extending through the second housing 21 in alignment with the passageways 13 of the base 10. The ledge 24 defines a top hole 25 in the middle thereof. The top hole 25 consists of two semicircle-shaped holes of different diameters. A pair of opposite stop walls 251 are provided at the junction of the two holes.

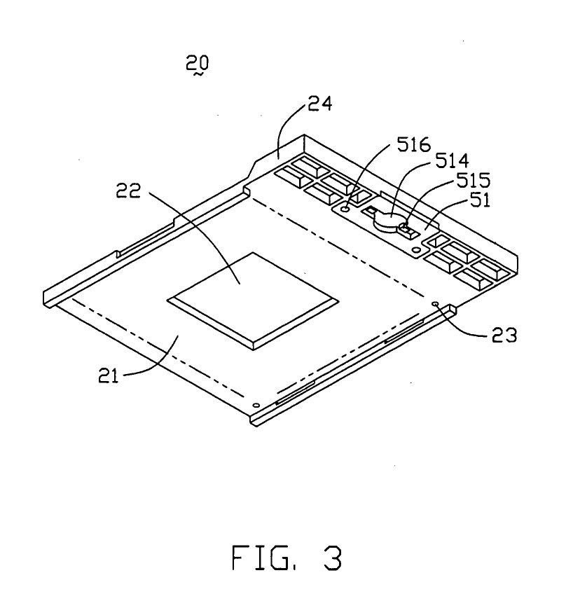

The protecting mechanism 50 comprises a T-shaped metallic cover plate 51 insert molded in the cover 20 (referring to FIG. 3) and a T-shaped metal bottom plate 52 received in the recess 14 of the base 10. The cover plate 51 comprises a body 511. The body 511 defines an elongated slot 512 in a middle thereof. A pair of arc-shaped holes 513 are provided on opposite sides of the slot 512 at a middle of and in communication with the slot 512. The two arc-shaped holes 513 define a through hole 514 together with a middle portion of the slot 512. A pair of upwardly extending cam stoppers 515 are provided on one side of the slot 512 and on opposite sides of one arc-shaped hole 513. The body 511 also defines a pair of small holes 516 for orientation of the cover plate 51 insert molded in the cover 20. The bottom plate 52 defines a rectangular or capsular through hole 521 in a middle thereof.

The cam actuator 40 comprises an upper disk 41, a lower disk 42 and a lower cam block 43. The upper disk 41 is coaxial with the lower disk 42 and has a diameter larger than the lower disk 42. The upper disk 41 defines an elongated groove 46 recessed in an upper surface thereof and comprises an outwardly protruding protrusion 45. The groove 46 has two closed opposing longitudinal ends. Thus, a tool can be confinedly fitted into the groove 46 to exert a rotation force on the cam actuator 40, without the possibility that the tool may slide along the groove 46 beyond the periphery of the upper disk 41. The cam block 43 is formed beneath the lower disk 42 and comprises a riveting end 44 coaxial with the cam block 43 at a lower end thereof. A rotational axis of the cam block 43 is offset from a rotational axis of the lower disk 42.

Referring to FIGS. 1 to 4, in assembly, first, the bottom plate 52 is received in the recess 14 of the base 10. Second, the cover 20 together with insert-molded the cover plate 51 is assembled onto the base 10. Successively, the cam actuator 40 is mounted into the ZIF socket 1 from the top via the top holes 25 and then through the through holes 514 and 521. The cam block 43 of the cam actuator 40 extends through the hole 521 of the bottom plate 52 and the riveting end 44 thereof is riveted with the washer 60 attached on a lower surface of the base 10, whereby the cam actuator 40, the cover 20, the base 10, and the washer 60 are assembled together.

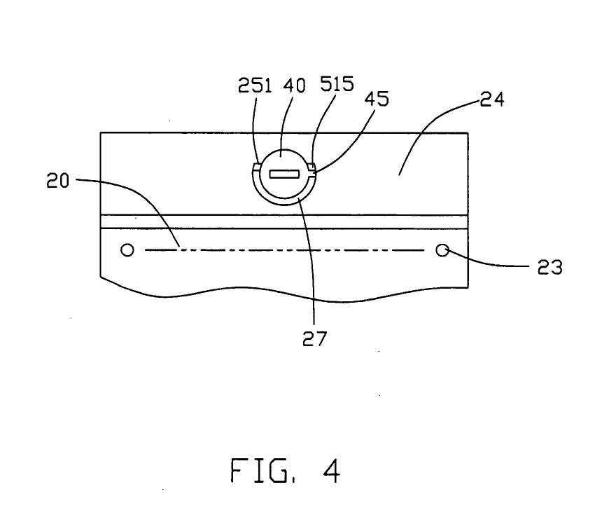

Referring to FIG. 4, an arc-shaped recess 27 is formed between the upper disk 41 of the cam actuator 40 and larger diameter semicircle-shaped hole of the top hole 25 of the cover 20. The protrusion 45 of the cam actuator 40 is rotatable in the arc-shaped recess 27. The cam stopper 515 of the cover plate 51 abuts against the stop wall 251 of the cover 20. In operation, after the CPU is loaded on the cover 20, the external tool (not shown) is fitted into the groove 46 to rotate the cam actuator 40 until the protrusion 45 thereof reaches one of the two limit positions defines by the two cam stoppers 515 and abuts against one of the cam stopper 515 of the cover plate 51 which abuts against the stop wall 251 of the cover 20. Since the axis of the cam block 43 is offset from the axis of the upper disk 41, the rotation of the cam actuator 40 forces the cover 20 to slide along the base 10 in a diagonal direction, thereby making the pins (not shown) of the CPU engage with the terminals 30 in the passageways 13. To open the pin-socket terminal connection, the cam actuator 40 is rotated in an opposite direction from one of the two cam stoppers 515, to the other cam stopper 515, thereby disengaging the pins of the CPU from the terminals 30 of the socket 1 and allowing the CPU to be removed from the cover 20.

When the protrusion 45 rotates between the two limit positions and abuts against the cam stopper 515, the cam stopper 515 can endure the large force exerted by the protrusion 45, thereby preventing the over rotation of the cam actuator 40 and protecting the stop wall 251 of the cover 20. Furthermore, since the cover plate 51 and the bottom plate 52 are made of a metallic material, the plastic area of the base 10 and the cover 20 abutted against by the cam actuator 40 is protected, giving it a longer life than the prior art plastic area, and in turn giving the electrical socket 1 a longer life. The cover plate 51 and the bottom plate 52 can also enhance the retention between the base and the cover 20.

While a preferred embodiment in accordance with the present invention has been shown and described, equivalent modifications and changes known to persons skilled in the art according to the spirit of the present invention are considered within the scope of the present invention as defined in the appended claims.

1. An electrical socket for electrically connecting an electronic package with a circuit substrate, the socket comprising:
a dielectric base defining a plurality of passageways for receiving a plurality of conductive terminals therein;
a cover slidably mounted on the base, the cover comprising a top hole and a plurality of passages in alignment with the passageways of the base, the top hole including two semicircle-shaped holes of different diameters and a pair of opposite stop walls at the junctions of the two semicircle-shaped holes;
a protecting mechanism positioned between the cover and the base, the protecting mechanism comprising a cover plate retained in the cover and a bottom plate received in the base, the cover plate defining a through hole in alignment with the top hole of the cover, and a pair of upwardly extending cam stoppers formed on opposite sides of the through hole and extending into the top hole of the cover;
a cam actuator rotatably engaged with the base, the cover, and the protecting mechanism for actuating the cover to slide on the base, the cam actuator having an upper disk received in the top hole of the cover, the upper disk having an outwardly protruding protrusion abutable against the cam stoppers during rotation; wherein
the protrusion rotates between two limit positions defined by the two stoppers and abuts against the stoppers to prevent over-rotation of the cam actuator and protect the stop walls of the cover.

2. The electrical socket as claimed in claim 1, wherein the cover plate is insert-molded in the cover.

3. The electrical socket as claimed in claim 1, the cam actuator comprises a washer, the washer riveting to an end of the cam actuator for assembling the cam actuator to the cover and the base.

4. The electrical socket as claimed in claim 1, wherein the cam stoppers extend upwardly and vertically from one side of the slot.

5. The electrical socket as claimed in claim 4, wherein the cam stoppers vertically extend upwardly from two opposite ends of the slot.

6. The electrical socket as claimed in claim 1, wherein the cam actuator comprises a lower disk and a lower cam block, the cam block comprising a riveting end coaxial with a lower end of the cam block.

7. The electrical socket as claimed in claim 1, wherein the base comprises a T-shaped recess in the middle of an end thereof, the T-shaped recess being provided for receiving the bottom plate.

8. The electrical socket as claimed in claim 1, wherein each of the cover plate and the bottom plate is formed from metallic material and is a T-shaped.

9. The electrical socket as claimed in claim 1, wherein an arc-shaped recess is formed between the upper disk of the cam actuator and one of the semicircle-shaped holes of the top hole, the recess being provided for the protrusion to be rotatable therein.

10. An electrical socket for electrically connecting an electronic package with a circuit substrate, the socket comprising:
a dielectric base defining a plurality of passageways for receiving a plurality of conductive terminals therein;
a cover slidably mounted on the base, the cover comprising a top hole and a plurality of passages in alignment with the passageways of the base;
a protecting mechanism positioned between the cover and the base, the protecting mechanism comprising at least one cover plate retained in the cover, the cover plate defining a through hole located below and in alignment with the top hole of the cover, and a pair of upwardly extending cam stoppers formed around opposite sides of the through hole and extending into the top hole of the cover; and
a cam actuator rotatably engaged with the base, the cover, and the protecting mechanism for actuating the cover to slide on the base, the cam actuator having an upper disk received in the top hole of the cover, the upper disk having an outwardly protruding protrusion abutable against the cam stoppers during rotation; wherein
the protrusion rotates between two limit positions defined by the two stoppers and abuts against the stoppers to prevent over-rotation of the cam actuator and protect the cover.

11. The electrical socket as claimed in claim 10, wherein said cam actuator further includes a lower disk located below the upper disk and received in the through hole for moving the protecting mechanism and the associated cover.

12. The electrical socket as clamed in claim 10, wherein said top hole defines a pair of opposite stop walls abutting against the two stoppers, respectively.

13. An electrical socket for electrically connecting an electronic package with a circuit substrate, the socket comprising:
a dielectric base defining a plurality of passageways for receiving a plurality of conductive terminals therein;
a cover slidably mounted on the base, the cover comprising a top hole and a plurality of passages in alignment with the passageways of the base;
a protecting mechanism positioned between the cover and the base, the protecting mechanism comprising at least one cover plate retained in the cover, the cover plate defining a through hole located below and in alignment with the top hole of the cover, and a pair of upwardly extending cam stoppers formed around opposite sides of the through hole and essentially located at a level same as either the top hole or the through hole; and
a cam actuator rotatably engaged with at least the base and the protecting mechanism for actuating the cover to slide on the base, the cam actuator having a disk received in the through hole for moving the protecting mechanism and the associated cover during rotation, and having further an outwardly protruding protrusion abut table against the cam stoppers during rotation; wherein
the protrusion rotates between two limit positions defined by the two stoppers and abuts against the stoppers to prevent over-rotation of the cam actuator and protect the cover.

14. The electrical socket as claimed in claim 13, wherein said stoppers are located at the same level with the top hole.
